(19) United States
(12) Patent Application Publication
(10) Pub. No.: US 2008/0243331 A1
(43) Pub. Date: Oct. 2, 2008

(54) Stop-off facility guidance systems, methods, and programs

(75) Inventor: Kazuya Kato, Okazaki (JP)

Correspondence Address: OLIFF & BERRIDGE, PLC, P.O. BOX 320850, ALEXANDRIA, VA, 22320-4850, US

(73) Assignee: AISIN AW CO., LTD., ANJO-SHI (JP)

(21) Appl. No.: 12/073,782

(22) Filed: Mar. 10, 2008

(30) Foreign Application Priority Data
Mar. 29, 2007 (JP) 2007-089314

(51) Int. Cl. G01M 17/00; G06F 19/00

(52) U.S. Cl. 701/30

(57) ABSTRACT

Stop-off facility guidance systems, methods, and programs calculate a time required for vehicle maintenance at a predetermined facility and calculate, for each of a plurality of stop-off facilities, a total time required for visiting the stop-off facility and returning to the predetermined facility on foot. The systems, methods, and programs compare each of the calculated total times with the time required for the vehicle maintenance and, based on the comparison, notify a driver of stop-off facilities which can be visited on foot or by other methods during the vehicle maintenance.

### INCORPORATION BY REFERENCE

The disclosure of Japanese Patent Application No. 2007-089314, filed on Mar. 29, 2007, including the specification, drawings and abstract thereof, is incorporated herein by reference in its entirety.

### BACKGROUND

1. Related Technical Fields

Related technical fields include stop-off facility guidance systems, methods, and programs.

2. Related Art

Traditionally, when the driver travels to a facility for vehicle maintenance, the driver must wait in a waiting room that is built in the facility and the like until the vehicle maintenance is finished. Similarly, when the driver goes to a gas station to wash the vehicle, the driver waits in a waiting room that is built in the gas station until the car wash is finished. When the driver goes to a motor vehicle repair shop to undergo the vehicle inspection and maintenance, the driver waits in a waiting room which is built in the motor vehicle repair shop until the vehicle inspection and maintenance is finished.

Further, if vehicle is an electric vehicle such as a hybrid vehicle or an electric-powered vehicle, when the driver goes to a battery charging facility such as an electric station or a parking area in which a battery charger is mounted, the driver waits in a waiting room which is built in the battery charging facility until the battery charge is finished.

However, when it takes a long time to finish the battery charge at the battery charging facility, it is difficult for the driver to wait until the battery charge is finished. Therefore, a vehicle disclosed in Japanese Unexamined Patent Application Publication No. 2006-112932 is provided with display information of stop-off points such as sightseeing facilities in conjunction with information of battery charging facilities, so that a driver can visit the sightseeing facilities and the like near the battery charging facility while the battery charges.

### SUMMARY

According to Japanese Unexamined Patent Application Publication No. 2006-112932, stop-off facilities near a battery charging facility are simply displayed, so that after the driver stops at the sightseeing facilities during the battery charge, the driver cannot know whether he/she could be back to the battery charging facility before the battery charge is terminated.

Various exemplary implementations of the broad principles described herein provide stop-off facility guidance system, methods, and programs that allow a driver, to know whether he/she could visit stop-off facilities near the predetermined facility on foot while vehicle maintenance is undergone at a predetermined facility.

Exemplary implementations provide stop-off facility guidance systems, methods, and programs that calculate a time required for vehicle maintenance at a predetermined facility and calculate, for each of a plurality of stop-off facilities, a total time required for visiting the stop-off facility and returning to the predetermined facility on foot. The systems, methods, and programs compare each of the calculated total times with the time required for the vehicle maintenance and, based on the comparison, notify a driver of stop-off facilities which can be visited on foot or by other methods during the vehicle maintenance.

### BRIEF DESCRIPTION OF THE DRAWINGS

Exemplary implementations will now be described with reference to the accompanying drawings, wherein:

FIG. 1 is a diagram showing an exemplary electric vehicle drive control system;

FIGS. 2 and 3 are flowcharts showing an exemplary stop-off guidance method;

FIG. 4 is an exemplary average stopover time table;

FIGS. 5 and 6 show examples of a stop-off facility guidance screens; and

FIG. 7 is an exemplary table of times required for watching/listening media.

### DETAILED DESCRIPTION OF EXEMPLARY IMPLEMENTATIONS

An example of a stop-off facility guidance system will be described below in which a hybrid vehicle travels to a parking area as a predetermined facility and a battery of the hybrid vehicle is charged as vehicle maintenance.

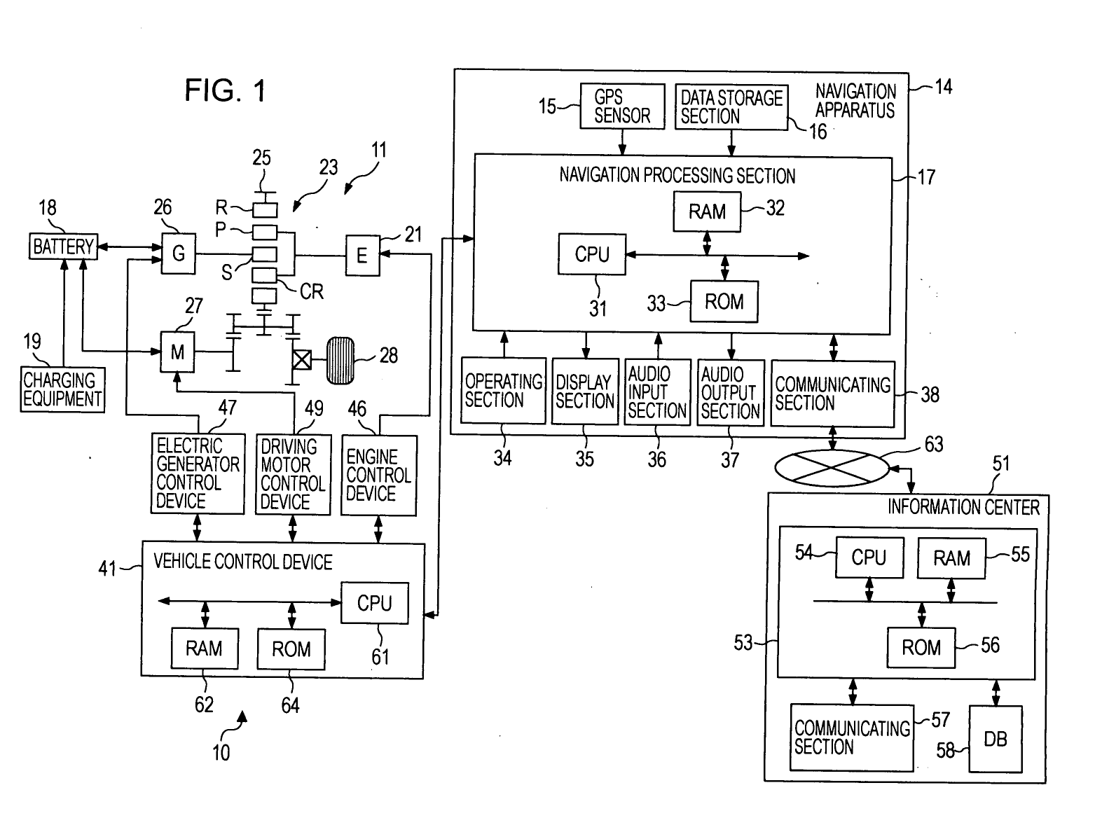

FIG. 1 is a diagram showing an exemplary electric vehicle drive control system according to an example of the current invention. As shown in FIG. 1, the system includes an electric vehicle drive control device 10, an electric drive device 11, an information terminal 14 such as, for example, a navigation apparatus as an in-vehicle device which is mounted in the hybrid vehicle. The system includes a network 63 and an information center 51 as an information provider. A navigation system may include the navigation apparatus 14, the network 63, and the information center 51. Further, an electric vehicle drive control system may include the navigation system, the electric vehicle drive control device 10, the electric drive device 11, and the like. Note that, a stop-off facility guidance system for providing guidance of stop-off facilities may include the electric vehicle drive control system.

The electric drive device 11 may include an engine (E) 21 as a first driving power source, a planetary gear unit 23 for shifting gears by changing the rotation which is transferred from the engine 21 and for allowing torque distribution as a differential rotating device, an output gear 25 for outputting the distributed torque by the planetary gear unit 23, and an electric generator (G) 26 as both a second driving power source which is connected to the planetary gear unit 23 and a first electric machine.

The planetary gear unit 23 may include at least a sun gear S as a first differential element, a pinion P meshing with the sun gear S, a ring gear R meshing with the pinion P as a second differential element, and a carrier CR supporting the pinion P rotatably as a third differential element. The sun gear S is connected to the electric generator 26. The ring gear R is connected to both a driving motor (M) 27, as a third driving power source and a second electric machine, and a driving wheel 28. The carrier CR is connected to the engine 21. The engine 21, the electric generator 26, and the driving motor 27 are connected to each other differential rotatably and mechanically through the planetary gear unit 23 while mechanically connected to the driving wheel 28 as well.

Note that, a one-way clutch (not shown) is mounted between the carrier CR and a case (not shown) of the electric vehicle drive control device 10, so that the inverse rotation is not transferred to the engine 21 because of the one-way clutch.

The electric generator 26 generates electricity using the rotation that is transferred from the planetary gear unit 23. Thereby, the electric generator 26 is connected to a battery 18 as a charging element and provides direct current to the battery 18. In the electric generator 26, an electric generator brake (not shown) is mounted between a rotor (not shown) and the case. The rotor is fixed by engaging with the electric generator brake, so that it is possible to mechanically stop the rotation of the electric generator 26.

Note that, according to the current example, it is possible to charge the battery 18 by supplying midnight power at a facility (point) such as a home and the like in which a predetermined charging equipment 19 is mounted for using commercial electricity. Therefore, an outlet (not shown) is mounted on the charging equipment 19 and a plug (not shown) is mounted on the hybrid vehicle and the battery 18 is connected to the charging equipment 19 by inserting the plug into the outlet. Note that, according to the current example, only the battery 18 is charged. However, for example, a capacitor as a charging element may be charged just as the battery 18.

The electric generator 26 is connected to the battery 18 through an electric generator inverter (not shown). The electric generator inverter converts direct current that is supplied from the battery 18 to phase U, phase V, and phase W, that is, alternating current and transfers alternating current to the electric generator 26. The electric generator 26 is activated in response to this and an electric generator torque, which is a torque of the electric generator 26, is generated.

The driving motor 27 is connected to the battery 18 through a driving motor inverter (not shown). The driving motor inverter converts direct current that is supplied from the battery 18 to phase U, phase V, and phase W, that is, alternating current and transfers alternating current to the driving motor 27. The driving motor 27 is activated in response to this and a driving motor torque, which is a torque of the driving motor 27, is generated. Note that, for example, while the hybrid vehicle is suspended, electricity that is regenerated by the driving motor 27 may be charged in the battery 18.

Next, the electric vehicle drive control device 10 for controlling the electric drive device 11 will be described. The electric vehicle drive control device 10 may include a vehicle control device 41 for controlling the entire hybrid vehicle. The vehicle control device 41 is connected to an engine control device 46 for controlling the engine 21, an electric generator control device 47 for controlling the electric generator 26, and a driving motor control device 49 for controlling the driving motor 27 while being connected to a navigation processing section 17 of the navigation apparatus 14.

The vehicle control device 41 may include a CPU 61, a RAM 62, which is used as a working memory when various types of calculating processing are executed by the CPU 61, and a ROM 64 in which control programs are stored. Each of the engine control device 46, the electric generator control device 47, and the driving motor control device 49 may include the CPU, the RAM, the ROM, and the like (not shown) to control the engine 21, the electric generator 26, or the driving motor 27.

Note that, a first control device which is at a lower level than the vehicle control device 41 may include the engine control device 46, the electric generator control device 47, the driving motor control device 49, and the navigation processing section 17. Similarly, a second control device which is at a higher level than the engine control device 46, the electric generator control device 47, the driving motor control device 49, and the navigation processing section 17 may include the vehicle control device 41.

The navigation apparatus 14 may include a GPS sensor 15 as a current position detecting section for detecting a vehicle position which is a current position of the hybrid vehicle and a vehicle direction which is the direction of the hybrid vehicle, a data storage section 16 as an information storage section for storing various information such as map data (not shown), the navigation processing section 17 for executing various calculation processing such as a navigation processing, and an operating section 34 as a first input section for operating a predetermined input by a driver's (a user's) operation. The navigation apparatus 14 may include a display section 35 as a first output section for proving various types of display using images which are displayed on a screen (not shown) and notifying the driver of the displays, an audio input section 36 as a second input section for operating a predetermined input by the driver's voice, an audio output section 37 as a second output section for operating audio output and notifying the driver of various information, and a communicating section 38 as a transferring/receiving section which is functioned as a communication terminal. The navigation processing section 17 is connected to the GPS sensor 15, the data storage section 16, the operating section 34, the display section 35, the audio input section 36, the audio output section 37, and the communicating section 38. The GPS sensor 15 detects a time in addition to the vehicle position and the vehicle direction. Note that, the vehicle direction may be detected by a direction sensor, which is mounted in addition to the GPS sensor 15.

The data storage section 16 may include a map database (not shown) including map data files containing map data. As map data, intersection data according to intersections (branch points), node data according to nodes, road data according to road links, search data that is modified for a search, facility data according to facilities, and feature data according to features on roads may be included.

The data storage section 16 may further include a statistical database (not shown) including statistical data files and a travel history database (not shown) including travel history data files. Statistical data is stored as past record data in the statistical data files and similarly travel history data is stored as past record data in the travel history data files.

The data storage section 16 may include a disk (not shown) such as a hard disk, a CD, a DVD, or an optical disk for storing various data described above and further include a head (not shown) such as a reading/writing head for reading/writing various data. For example, a memory card may be used as the data storage section 16. Note that, an external storage device may be structured by each of the disks described above and/or the memory card.

According to the current example, the map database, the statistical database, the travel history database, and the like are included in the data storage section 16. However, the map database, the statistical database, the travel history database, and the like may be included in the information center 51.

The navigation processing section 17 may include a CPU 31 as a control device for controlling the entire navigation apparatus 14 and as a calculating device, a RAM 32 which is used as a working memory when the CPU 31 executes various calculating processing, a ROM 33 in which control programs and various programs for operating a route search for a destination, a route guidance, and the like are stored, and a flash memory (not shown) which is used for storing various data and programs.

As the operating section 34, a keyboard or a mouse (not shown), which is mounted in addition to the display section 35, may be used. Further, a touch panel may be used as the operating section 34 for executing predetermined input operations. Specifically, an image operating section such as various types of keys, switches, and/or buttons displayed as an image on a screen of the display section 35, that is, the touch panel, is touched or clicked and the predetermined input operations are executed.

A display may be used as the display section 35. The vehicle position, the vehicle direction, a map, a route to be searched for, guidance information and traffic information along the searched route, a distance to next intersection along the searched route, and a travel direction at next intersection may be displayed.

The audio input section 36 may include a microphone (not shown) to input necessary information by voice. The audio output section 37 may include an audio synthesis device and a speaker (not shown) to provide route guidance according to the searched route with audio output.

The communicating section 38 may include a beacon receiver (not shown) for receiving various information such as general information and/or current traffic information which are transferred from a road traffic information center such as a VICS (Vehicle Information and Communication System®) center and an FM receiver (not shown) for receiving FM multiple broadcasting through an FM broadcasting station. In addition to various information such as general information and traffic information, the communicating section 38 may receive data such as map data, statistical data, travel history data, and the like from the information center 51 through the network 63.

To transfer such data, the information center 51 may include a server 53, a communicating section 57, and a database (DB) 58 as an information storage section. The server 53 may further include a CPU 54, a RAM 55, and a ROM 56. In the database 58, same data as various data that is stored in the data storage section 16 is stored.

Note that, the electric vehicle drive control system, the electric vehicle drive control device 10, the engine control device 46, the electric generator control device 47, the driving motor control device 49, the navigation system, the navigation processing section 17, the server 53, the CPUs 31, 54, and 61 may be implemented by a single controller (CPU) or a plurality of CPUs for executing calculating processing based on various programs and data.

A storage device and a storage medium may be structured with the data storage section 16, the RAMs 32, 55, 62, the ROMs 33, 56, 64, and a flash memory. A calculating device may be structured with the CPU 31, 54, and 61. As the calculating device, for example, a MPU may be used instead of the CPU 31, 54, or 61.

Next, basic operations of the navigation apparatus 14 will be described. First, when a driver operates the operating section 34 and the navigation apparatus 14 is activated, the CPU 31 executes a current position reading processing, so that a vehicle position and a vehicle direction, which are detected by the GPS sensor 15, are read. Next, the CPU 31 executes a vehicle position calculating processing (matching processing), so that the vehicle position is calculated and specified by determining which road link the vehicle position is located on based on the locus of the read vehicle positions and shapes and orders of road links which are formed roads surrounding the vehicle position.

The CPU 31 executes a basic information obtaining processing for reading out and obtaining the map data from the data storage section 16 or for receiving and obtaining the map data from, for example, the information center 51 through the communicating section 38. Note that, when the map data is obtained from, for example, the information center 51, the CPU 31 downloads the received map data onto the flash memory.

The CPU 31 executes a display processing for creating various types of screens on the display section 35. For example, the CPU 31 executes a map display processing, so that a map screen is generated on the display section 35 and a map of a surrounding area, the vehicle position, and the vehicle direction are displayed on the map screen.

Therefore, the driver can drive the vehicle based on the displayed map data, the vehicle position, and the vehicle direction.

When the driver inputs a destination by operating the operating section 34, the CPU 31 executes a destination setting processing for setting the destination. Note that, according to the current example, instead of operating the operating section 34 to input the destination, the driver can input an activity schedule indicating a travel plan of the hybrid vehicle using a terminal device (not shown) such as an electric personal organizer, a PC, and the like. Therefore, the navigation apparatus 14 may include the communicating section 38 for transferring/receiving data with a connector or a PC (not shown), which is for connecting the electric personal organizer and the like.

In the activity schedule, for example, starting points, destinations, scheduled starting times at the starting points, and scheduled arrival times at the destinations are stored by date.

Next, in the navigation apparatus 14, the CPU 31 executes an activity schedule obtaining processing, so that the activity schedule which was input from the terminal device is read and obtained before the hybrid vehicle starts traveling, and the activity schedule, connecting a starting at a home as a first starting point to an arrival to the home as a last destination through each of destinations, is set as a destination schedule.

The destination schedule is set as described above. If needed, the driver inputs search conditions by operating the operating section 34 and the CPU 31 executes a search processing, so that the vehicle position, the destination schedule, and the like are read, search data and charging facility data of a parking area, an electric station, and the like, which includes a charging equipment (hereinafter referred to as “charging facility data”) are read out among facility data, a route from the first starting point to the last destination on the destination schedule is searched for according to the search conditions based on the vehicle position, the destination, search data, charging facility data, and the like, and finally the route data is output.

Note that, the searched route is a collection of routes that are from each starting point to each destination on the destination schedule. Route data may include, not only data indicating searched routes, but data indicating charging facilities that are searched for on the searched routes. According to the search processing, the route which has the minimum total link cost, a link cost is assigned to each road link, is searched for.

According to the current example, the CPU 31 executes the search processing. However, the information center 51 may execute the search processing instead.

The CPU 31 executes a guidance processing and the route guidance. The CPU 31 executes a route display processing, so that the route data is read in and the searched route is displayed on the map screen based on the read route data.

Meanwhile, the electric generator 26 and the driving motor 27 are activated by electric current that is supplied from the battery 18. In this case, it is preferable to run down the electricity that was charged in the battery 18 before the next charge in terms of a pollution issue and/or an energy-saving problem. However, if the electricity is run down while the hybrid vehicle is traveling, the hybrid vehicle has to travel using only the engine 21 in spite of a HV travel mode and this is not preferable in terms of the pollution issue and/or the energy-saving problem. Further, a vehicle request torque that is necessary for driving the hybrid vehicle cannot be generated enough.

To solve the problems described above, according to the current example, the navigation apparatus 14 sets charging facilities as planned charging points based on the search data and each of ideal battery remaining amounts (SOC) at charging points along the routes between each starting point (at which the battery can be charged) and each planned charging point is set as a target value of the battery remaining amount SOC, that is, a target battery remaining amount SOC* as a target charging capacity. The navigation apparatus 14 calculates the target battery remaining amount SOC* as the target charging capacity.

The CPU 31 executes an energy control determination processing as a charging schedule setting processing. As charging conditions, the battery remaining amount SOC as the charging capacity at the first starting point, the distance from the starting point at which the hybrid vehicle can be charged to the planned charging point, a time spent on charging at each planned charging point between the arrival at the point and the departure from the point (that is, a time period which can be spent at the charging point), a time necessary for full-charging the battery 18 (that is, a time required for charging), and the like are read in and the travel distance from the starting point at which the vehicle can be charged is calculated based on the charging conditions. Next, the target battery remaining amounts SOC* at each of points are calculated in such a way that the battery remaining amount SOC becomes 0% at the arrival to the next planned charging point. In this way, the charging schedule including the target battery remaining amounts SOC* at each of points is set.

Note that, a facility at which maintenance will be undergone (that is, a planned maintenance point) is set from the planned charging points. A maintenance and charging time at each of the planned maintenance points is set based on the time which can be spent at the charging point. A time required for the maintenance is set based on the time required for charging.

The battery remaining amount SOC denotes a value indicating the percentage of the charge amount which is actually charged in the battery 18 against the capacity of the battery 18, that is, the amount of charge remaining in the battery. When the battery 18 is full-charged and the percentage of the charge vs. the capacity of the battery 18 is 100%, the battery remaining amount SOC is 100%.

To calculate the battery remaining amount SOC, a battery voltage sensor and a battery current sensor may be mounted in the battery 18. The sensor output from the battery voltage sensor and the sensor output from the battery current sensor are supplied to the vehicle control device 41. In response to this, the vehicle control device 41 executes a battery remaining amount calculating processing as an amount of charge calculating processing for calculating the battery remaining amount SOC.

In this case, the first starting point and the last destination are both the home. The battery 18 is full-charged at the departure at the home, so that the battery remaining amount SOC at that time is 100%, and the battery remaining amount SOC becomes 0% at the arrival at the home. Each of the battery remaining amounts SOC at each of the planned charging points is nearly 0% so as to charge the battery of the vehicle at the planned charging points. Note that, when the time which can be spent at the planned charging point is shorter than the time required for charging, the charging is started as soon as the vehicle arrives at the planned charging point and the charging is terminated when the vehicle leaves from the point. In this case, although the battery remaining amount SOC does not reach 100%, the vehicle goes to the next destination.

Note that, as the battery remaining amount SOC here, 100% and 0% do not indicate the physical remaining amount. 100% and 0% of SOC indicate the highest remaining amount and the lowest remaining amount based on the economical repeated use of the battery 18. Further, the battery remaining amount SOC is different depending on the cause of the performance, the material, and the like of the battery 18. For example, when the battery 18 is an alkaline battery, the battery may be used until the SOC becomes very low. Meanwhile, when the battery 18 is a zinc battery, using the zinc battery until the SOC becomes excessively low causes the battery life to be shortened, so that a state which a predetermined amount of charge is still remaining in the zinc battery is set as 0% of the battery remaining amount SOC for the zinc battery.

As described above, when the charging schedule is set, the CPU 31 executes a drive control instruction processing, so that the charging schedule which is the determination result by the energy control determination processing is notified to the electric vehicle drive control device 10 and the activation of the electric drive device 11 is instructed.

The CPU 61 executes a drive control processing and activates the electric drive device 11 based on the charging schedule. Operations of the CPU 61 will be described.

First, the CPU 61 executes a driving condition obtaining processing, so that a position of an accelerator pedal is read from an accelerator switch which is mounted on the accelerator pedal (not shown) and a position of a brake pedal is read from a brake switch which is mounted on the brake pedal (not shown). Further, a position of a rotor is read from a rotor position sensor (for example, a resolver) (not shown) as a position detecting section, which is mounted on the driving motor 27, and the vehicle speed is calculated as a travel condition based on the rotor position. In this case, the accelerator switch and the brake switch are functioning as driving operation amount detecting sections and the rotor position sensor is functioning as a vehicle speed detecting section. Note that, the vehicle speed may be detected by a vehicle speed sensor that is mounted on the output gear 25 as the vehicle speed detecting section.

The CPU 61 executes a vehicle request torque calculating processing, so that a vehicle request torque TO* which is necessary for driving the hybrid vehicle is calculated based on the accelerator pedal position, the brake pedal position, and the vehicle speed.

Next, the CPU 61 executes a vehicle request torque determination processing, to determine whether the vehicle request torque TO* is greater than a driving motor maximum torque which is a preset maximum driving motor torque as a rating torque of the diving motor 27. When the vehicle request torque TO* is greater than the driving motor maximum torque, the CPU 61 executes an abrupt acceleration control processing, to determine whether the engine 21 is suspended. When the engine 21 is suspended, the electric generator 26 and the driving motor 27 are activated to make the hybrid vehicle travel in the EV travel mode.

When the vehicle request torque TO* is equal to or less than the driving motor maximum torque or when the vehicle request torque TO* is greater than the driving motor maximum torque while the engine 21 is not suspended, the CPU 61 executes a driver request output calculating processing. A driver request output PD is calculated by multiplying the vehicle request torque TO* by the vehicle speed. The CPU 61 executes a battery charge-discharge request output calculating processing. The charging schedule is read from the navigation apparatus 14 while the battery remaining amount SOC is read. Then, a battery charge-discharge request output LSOC is calculated as a charge-discharge request output in such a way that the current battery remaining amount SOC is brought close to the target battery remaining amount SOC* of the charging schedule. The CPU 61 executes a vehicle request output calculating processing, so that a vehicle request output PO is calculated by adding the driver request output PD to the battery charge-discharge request output LSOC.

Next, the CPU 61 executes an engine target driving condition setting processing. An engine target driving condition map which is stored in the ROM 64 is referred to determine a driving point which is a point at which the efficiency of the engine 21 becomes the highest on a most suitable fuel efficiency curve based on the vehicle request output PO, the accelerator pedal position, and the like. The torque of the engine 21 at the determined driving point, that is, an engine torque TE, is determined as an engine target torque TE* indicating the target value of the engine torque TE. Further, an engine rotation speed at the determined driving point, that is, an engine rotation speed NE, is determined as an engine target rotation speed NE* indicating the target value of the engine rotation speed NE and the engine target rotation speed NE* is transferred to the engine control device 46.

The engine control device 46 refers to an engine drivable range map which is stored in the ROM as a storage device of the engine control device 46 and determines whether the electric drive device 11 is located within a drivable range which is for activating the engine 21 based on the vehicle speed, the battery remaining amount SOC, and the vehicle request torque TO*. In this case, the greater the battery remaining amount SOC is, the narrower the drivable range becomes. Similarly, the smaller the battery remaining amount SOC is, the larger the drivable range becomes.

When the engine 21 is not activated even though the engine 21 is located within the drivable range, the engine control device 46 executes an engine control processing. In this processing, the engine 21 starts to be activated to make the hybrid vehicle travel in the HV travel mode. When the engine 21 is activated even though the engine 21 is not located within the drivable range, the driving of the engine 21 is terminated and the hybrid vehicle is made to travel in the EV travel mode.

When the engine 21 is not located within the drivable range and not activated, the CPU 61 executes a driving motor target torque calculating processing. The vehicle request torque TO* is calculated as a driving motor target torque TM* indicating the target value of the driving motor torque TM and the calculated driving motor target torque TM* is transferred to the driving motor control device 49. In this case, the driving motor control device 49 executes a driving motor control processing for controlling the torque of the driving motor 27.

When the engine 21 is located within the drivable range and activated, the engine 21 is controlled using a predetermined method.

Next, the electric generator control device 47 executes an electric generator target rotation speed calculating processing. Specifically, the electric generator control device 47 reads the rotor position from the rotor position sensor and calculates the rotation speed of the ring gear R based on the rotor position. At the same time, the engine target rotation speed NE* is read and the rotation speed of the electric generator 26, that is, an electric generator target rotation speed NG* indicating the target value of the electric generator rotation speed NG is calculated based on the rotation speed of the ring gear R and the engine target rotation speed NE* because the rotation speed of the electric generator 26 responds to the engine target rotation speed NE* by a rotation speed's relational expression which is represented by a gear teeth ratio of the sun gear S, the pinion P, and the ring gear R of the planetary gear unit 23.

By the way, when the hybrid vehicle which has the structure described above is driven by using the engine 21 and the driving motor 27 in the HV travel mode, if the electric generator rotation speed NG is low, it requires a measurable amount of power and the power generation efficiency of the electric generator 26 becomes down, so that the fuel efficiency of the hybrid vehicle becomes lower. Therefore, when the electric generator rotation speed NG is low, the brake of the electric generator is engaged and the electric generator 26 is stopped mechanically. As the result, the fuel efficiency becomes better.

When the electric generator target torque TG* indicating the target value of the electric generator torque TG is determined, the electric generator control device 47 controls the torque of the electric generator 26 based on the electric generator target torque TG*. A predetermined electric generator torque TG is generated and an engine torque TE, the torque of the ring gear R, that is, the ring gear torque, and the electric generator torque TG receive reaction forces from each other, so that the electric generator torque TG is converted to the ring gear torque and output from the ring gear R. In this case, the ring gear torque is output from the ring gear R and the electric generator rotation speed NG is changed and further the ring gear torque is changed as well. The changed ring gear torque is transferred to the driving wheel 28, so that the sensation of driving of the hybrid vehicle becomes worse.

The CPU 61 calculates the ring gear torque in prospect of the torque for inertia of the electric generator 26 depending on the change of the electric generator rotation speed NG and estimates a torque of an output shaft of the driving motor 27, that is, a driving shaft torque based on the ring gear torque. By subtracting the driving shaft torque from the vehicle request torque TO*, the over-short value of the driving shaft torque is calculated as the driving motor target torque TM*.

In the current example described above, according to the driving conditions such as the charging schedule, the acceleration pedal position, the brake pedal position, the vehicle speed, the battery remaining amount SOC, and the like, the hybrid vehicle travels in the EV travel mode by terminating the engine 21 and activating both the electric generator 26 and the driving motor 27 or by terminating both the engine 21 and the electric generator 26 and activating only the driving motor 27. Meanwhile, the hybrid vehicle travels in the HV travel mode by activating both the engine 21 and the driving motor 27 and activating the electric generator 26 to receive the reactive force, or by activating both the engine 21 and the driving motor 27 and mechanically terminating the electric generator 26.

When a predetermined charging facility, for example, a parking area is set as the planned charging point, guidance of facilities near the parking area is provided as well, so that the driver can visit the facilities while the vehicle is charged at the parking area.

The CPU 31 executes a stop-off guidance processing, so that stop-off facilities are searched for and guidance of the searched facilities is provided to the driver.

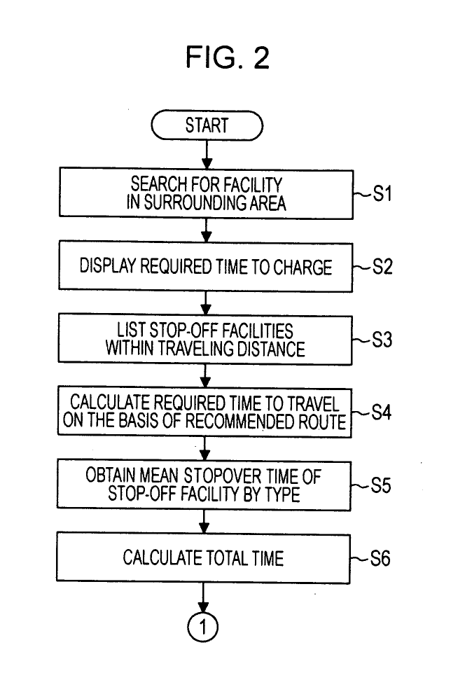

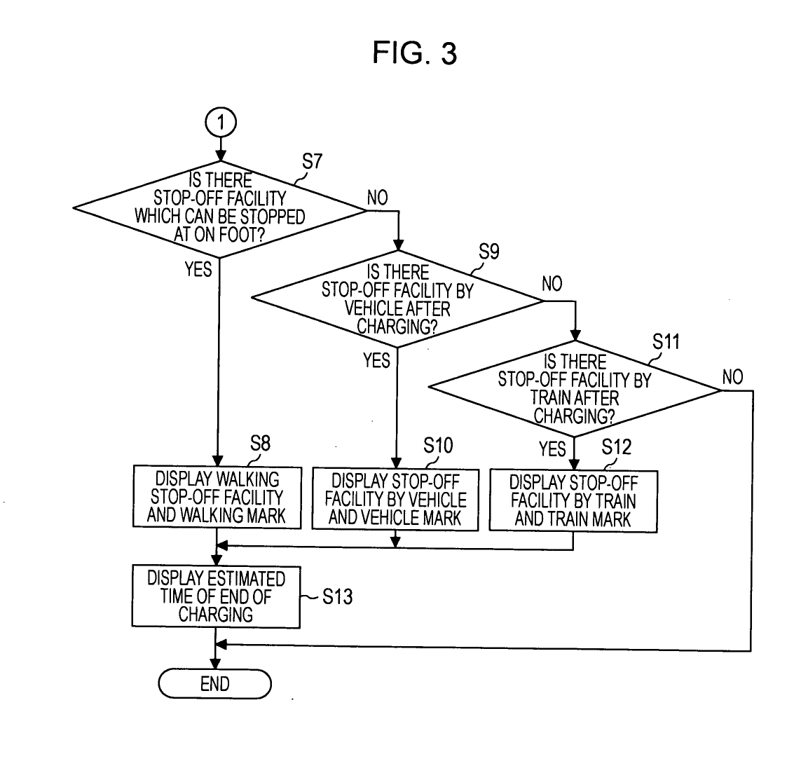

FIGS. 2 and 3 are flowcharts showing an exemplary stop-off guidance method according to the example of the current invention. The exemplary method may be implemented, for example, by one or more components of the above-described system. However, even though the exemplary structure of the above-described system may be referenced in the description, it should be appreciated that the structure is exemplary and the exemplary method need not be limited by any of the above-described exemplary structure. For example, the method may be implemented by the CPU 31 executing a program stored in the ROM 33.

In the method, the CPU 31 refers to facility data and searches for facilities that are located within an area surrounding a parking area (SI). According to the current example, as stop-off facilities, only facilities within travel distances that can be visited on foot, by the hybrid vehicle, or by train are searched for. In this case, facilities within a range that can be visited on foot (for example, within a 1000-meter radius) are set as walk stop-off facilities. Similarly, facilities within driving distance by the hybrid vehicle (for example, a 20-kilometer radius in case of general roads or a 80-kilometer radius in case of highway) are set as vehicle stop-off facilities, and facilities within movable distance by train are set as train stop-off facilities.

Next, the CPU 31 reads the current battery remaining amount SOC and calculates the time required for charging by the charging equipment at the parking area on the basis of the battery remaining amount SOC. Then, the CPU 31 displays the time required for charging on the display section 35 (S2). Then, the CPU lists the set stop-off facilities (S3)

The CPU 31 sets the parking area as the starting point, searches for routes to each of stop-off facilities as the destinations, and sets the searched routes as stop-off routes. Then, the CPU 31 executes a total time calculating processing. Specifically, a time which is necessary for visiting a walk stop-off facility on foot from the parking area among the searched stop-off facilities, that is, a walking time as a first travel time, a time which is necessary for visiting a vehicle stop-off facility by the hybrid vehicle from the parking area among the searched stop-off facilities, that is, a vehicle travel time as a second travel time, and a time which is necessary for visiting a train stop-off facility by train from the parking area among the searched stop-off facilities, that is, a train travel time as a third travel time are calculated on basis of each of the stop-off routes (S4).

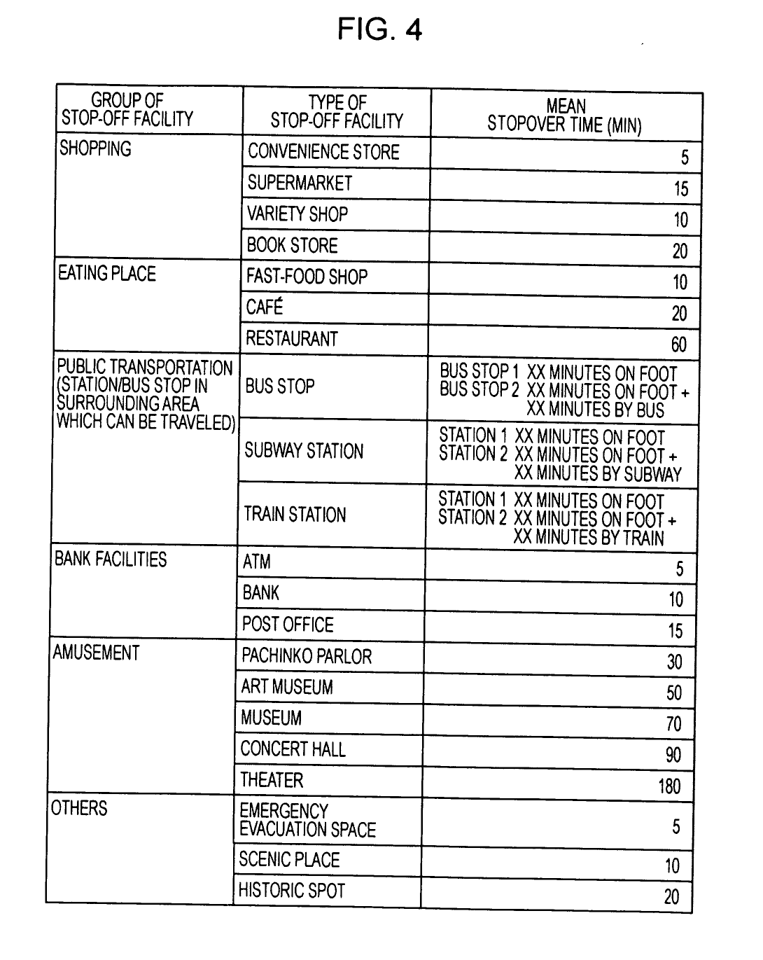

The CPU 31 determines whether a type of the stop-off facility is known. When the type of the stop-off facility is known, the total time calculating processing means refers to the mean stopover time table that is set in the ROM 33 (e.g., as shown in FIG. 4) and reads out and obtains the mean stopover times of the stop-off facilities by type (S5). Meanwhile, when the type of the stop-off facility is not known, the total time calculating processing means reads out and obtains a standard mean stopover time (hereinafter referred to as “standard stopover time”) which is uniformly set and stored in, for example, a buffer (not shown) of the CPU 31. However, the standard stopover time may be stored in a predetermined range of the mean stopover time table separate from the mean stopover times by type. Note that, in the mean stopover time table, the stop-off facilities are sorted by group and further by type and the mean stopover times corresponding to each of the types of the stop-off facilities are sorted and stored. The mean stopover time table may be set in the data storage section 16, the database 58, and the like, instead of the ROM 33.

The CPU 31 calculates a round-trip time between the parking area and the stop-off facility by doubling the walking time, the vehicle travel time, or the train travel time Further, the total time, which is a total time necessary for leaving the parking area, stopping at the stop-off facility, staying at the stop-off facility for the corresponding mean stopover time, and getting back to the parking area from the stop-off facility, is calculated by adding the calculated round-trip time to the mean stopover time (S6). In this case, the total times for each of the walk stop-off facilities, the total times for each of the vehicle stop-off facilities, and the total times for each of the train stop-off facilities are calculated.

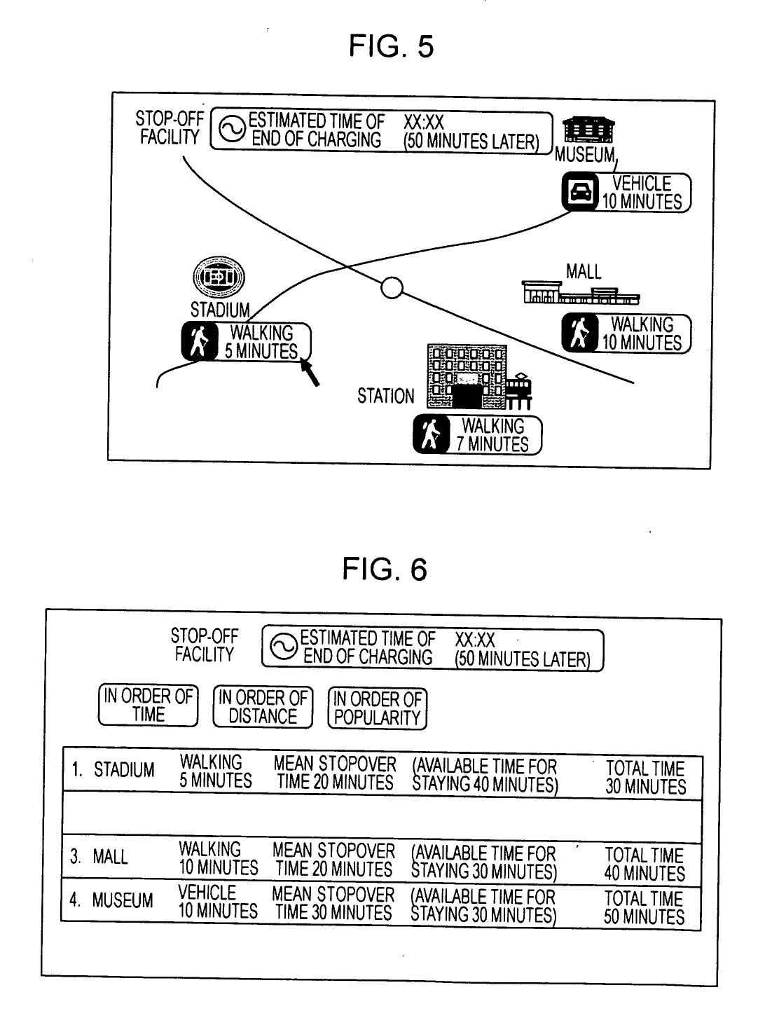

The CPU 31 compares the total times of each of the walk stop-off facilities with the time required for charging to determine whether there is any walk stop-off facility whose total time is shorter than the time required for charging (S7). When such a walk stop-off facility can be visited on foot exists (S7=YES), the CPU 31 displays the walk stop-off facility and the walking time with a mark indicating that the facility can be visited on foot, that is, a walking mark, on the map as shown in FIG. 5 (S8).

When a walk stop-off facility which can be visited on foot does not exist (S7=NO), the CPU 31 compares the total times of the vehicle stop-off facilities with a first threshold value to determine whether there is any vehicle stop-off facility whose total time is shorter than the first threshold value (that is, whether there is any vehicle stop-off facility which can be visited after the charging) (S9). When a vehicle stop-off facility which can be visited by vehicle exists (S9=YES), the CPU 31 displays the vehicle stop-off facility and the vehicle travel time with a mark indicating that the facility can be visited by the hybrid vehicle, that is, a vehicle mark, on the map as shown in FIG. 5 (S10).

When a vehicle stop-off facility which can be visited by the hybrid vehicle does not exist (S9=NO), the CPU 31 compares the total times of each of the train stop-off facilities with a second threshold value to determine whether there is any train stop-off facility whose total time is shorter than the second threshold value (that is, whether there is any train stop-off facility which can be visited after the charging) (S11). When a the train stop-off facility which can be visited exists (S11=YES), the CPU 31 displays the train stop-off facility and the train travel time with a mark indicating that the facility can be visited by train, that is, a train mark, on the map (S12).

One a mark for a facility has been displayed (S8, S10, S12), the CPU 31 displays a planned time of the end of the charging, that is, an expected time of end of charging, on a predetermined area of the screen (S13). The CPU 31 may further display the mean stopover times and the available times for staying at the facilities on the map.

According to the current example, the CPU 31 determines whether there is any stop-off facility whose total time is shorter than the time required for charging. When there is such a stop-off facility whose total time is shorter than the time required for charging, the CPU 31 displays the determined stop-off facility on the map. However, in case of that the driver sets an allowable time in advance, the CPU 31 may display the stop-off facility whose total time is the allowable time longer than the time required for charging on the map.

As shown in FIG. 6, the stop-off facilities may be displayed in a list form on the display section 35. In this case, for example, the stop-off facilities, the walking times, the vehicle travel times, the train travel times, the mean stopover times, the available times for staying, the total times, and the like may be displayed. Further, the stop-off facilities may be displayed in ascending order of the total times, in ascending order of the distances to the stop-off facilities, in the order of popularity, and the like.

Note that, it is possible to notify the driver that the charging is terminated at the timing of the end of the charging. In this case, the CPU 31 determines whether the charging is terminated. When the charging is terminated, the CPU 31 notifies the driver that the charging is terminated by, for example, sending a mail to a mobile phone or any other communicating device or communicating terminal.

As described above, according to the current example, the walk stop-off facility whose total time is shorter than the time required for charging is displayed on the display section 35, so that the driver may predict when he/she should get back to the parking area after visiting the displayed stop-off facility on foot. This prevents the driver from coming back to the parking area much earlier than the termination of charging or from coming back to the parking area much later than the termination charging. Thus, it is possible to improve the convenience of the display according to the stop-off facility. Further, after the charging is terminated, the vehicle stop-off facilities which can be visited by the hybrid vehicle or the train stop-off facilities which can be visited by train may be displayed on the display section 35, so that it is possible for the driver to easily determine whether the stop-off facility should be visited before the charging is terminated or after the charging is terminated.

According to the current example, the CPU 31 notifies the driver of the stop-off facilities that can be visited by methods other than on foot after the maintenance is terminated. However, it is possible to notify the driver of the stop-off facilities that can be visited by methods other than on foot before the maintenance is terminated, if needed.

According to the current example, the total times of each of the walk stop-off facilities are compared with the time required for charging. When there is any walk stop-off facility that can be visited, the walk stop-off facility and the walking time are displayed with the walking mark. When the walk stop-off facility that can be visited does not exist, the vehicle stop-off facilities and the vehicle travel times are displayed on the map with the vehicle marks and/or the train stop-off facilities and the train travel times are displayed on the map with the train marks. However, when such the walk stop-off facility that can be visited does not exist, it is possible to provide the guidance of video/audio programs that can be watched/listened within the time required for charging.

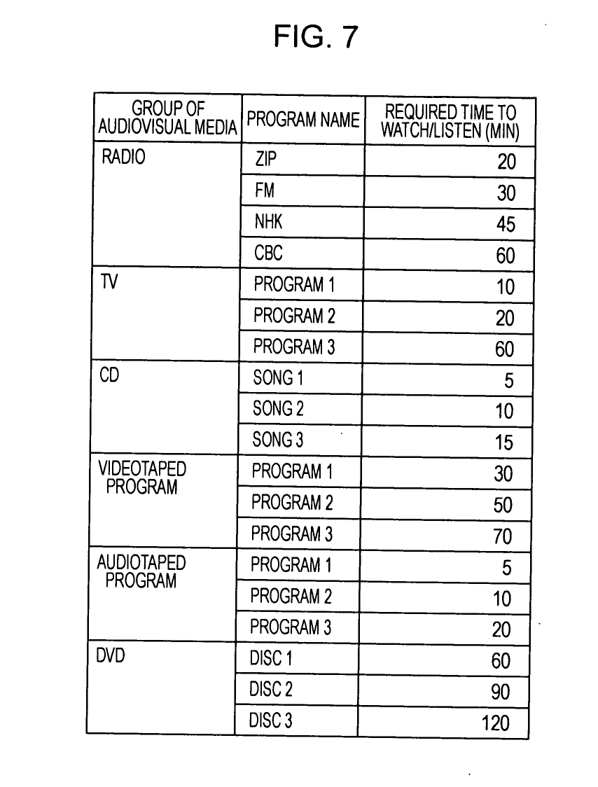

Next, an example in which the guidance of video/audio programs which can be watched/listened within the time required for charging is provided will be described. FIG. 7 is a diagram showing a table of times required for watching/listening media.

In this example, when it is determined that the walk stop-off facility which can be visited does not exist, the CPU 31 executes a media guidance processing. A table of times required for watching/listening media which is set in the ROM 33 is referred to as shown in FIG. 7 and programs which can be watched/listened within the time required for charging are searched for. The CPU 31 displays the searched programs that can be watched/listened on the display section 35. In this case, the CPU 31 notifies the driver of programs that can be watched/listened.

While various features have been described in conjunction with the examples outlined above, various alternatives, modifications, variations, and/or improvements of those features and/or examples may be possible. Accordingly, the examples, as set forth above, are intended to be illustrative. Various changes may be made without departing from the broad spirit and scope of the underlying principles.

What is claimed is:

1. A stop-off facility guidance system for a vehicle, comprising:
a controller that:
calculates a time required for vehicle maintenance at a predetermined facility;
for each of a plurality of stop-off facilities, calculates a total time required for visiting the stop-off facility and returning to the predetermined facility on foot;
compares each of the calculated total times with the time required for the vehicle maintenance; and
based on the comparison, notifies a driver of stop-off facilities which can be visited on foot during the vehicle maintenance.

2. The stop-off facility guidance system of claim 1, wherein the controller calculates the total time for each of the plurality of stop-off facilities based on:
a time required to travel between the predetermined facility and the stop-off facility; and
a mean stopover time for the stop-off facility.

3. The stop-off facility guidance system of claim 1, wherein the controller notifies the driver of a stop-off facility which can be visited on foot when the calculated total time for that stop-off facility is shorter than the time required for the vehicle maintenance.

4. The stop-off facility guidance system of claim 1, wherein the controller displays the stop-off facilities which can be visited on foot and marks indicating that the stop off facilities can be visited on foot on a map.

5. The stop-off facility guidance system of claim 1, wherein the controller displays the stop-off facilities in a list form.

6. The stop-off facility guidance system of claim 1, wherein the controller provides a notification of programs that can be watched or listened to within the time required for the vehicle maintenance.

7. The stop-off facility guidance system of claim 1, wherein the controller notifies the driver of stop-off facilities that can be visited by methods other than on foot.

8. The stop-off facility guidance system of claim 1, wherein the controller notifies the driver of an estimated time required for the vehicle maintenance.

9. The stop-off facility guidance system of claim 1, wherein:
the vehicle comprises an electric driving motor; and
the vehicle maintenance is a charging of a charging element that supplies electric power to a battery, the battery supplying electric power to the driving motor.

10. A navigation apparatus comprising the stop-off facility guidance system of claim 1.

11. A stop-off facility guidance method, comprising:
calculating a time required for vehicle maintenance at a predetermined facility;
calculating, for each of a plurality of stop-off facilities, a total time required for visiting the stop-off facility and returning to the predetermined facility on foot;
comparing each of the calculated total times with the time required for the vehicle maintenance; and
based on the comparison, notifying a driver of stop-off facilities that can be visited on foot during the vehicle maintenance.

12. The stop-off facility guidance method of claim 11, further comprising calculating the total time for each of the plurality of stop-off facilities based on:
a time required to travel between the predetermined facility and the stop-off facility; and
a mean stopover time for the stop-off facility.

13. The stop-off facility guidance method of claim 11, further comprising notifying the driver of a stop-off facility which can be visited on foot when the calculated total time for that stop-off facility is shorter than the time required for the vehicle maintenance.

14. The stop-off facility guidance method of claim 11, further comprising displaying the stop-off facilities which can be visited on foot and marks indicating that the stop off facilities can be visited on foot on a map.

15. The stop-off facility guidance method of claim 11, further comprising displaying the stop-off facilities in a list form.

16. The stop-off facility guidance method of claim 11, further comprising providing a notification of programs that can be watched or listened to within the time required for the vehicle maintenance.

17. The stop-off facility guidance method of claim 11, further comprising notifying the driver of stop-off facilities that can be visited by methods other than on foot.

18. The stop-off facility guidance method of claim 11, further comprising notifying the driver of an estimated time required for the vehicle maintenance.

19. The stop-off facility guidance method of claim 11, wherein:
the vehicle comprises an electric driving motor; and
the vehicle maintenance is a charging of a charging element that supplies electric power to a battery, the battery supplying electric power to the driving motor.

20. A computer-readable storage medium storing a computer-executable program usable to provide stop-off facility guidance, the program comprising:
instructions for calculating a time required for vehicle maintenance at a predetermined facility;
instructions for calculating, for each of a plurality of stop-off facilities, a total time required for visiting the stop-off facility and returning to the predetermined facility on foot;
instructions for comparing each of the calculated total times with the time required for the vehicle maintenance; and
instructions for based on the comparison, notifying a driver of stop-off facilities that can be visited on foot during the vehicle maintenance.
